(19) United States
(12) Patent Application Publication
(10) Pub. No.: US 2018/0201540 A1
(43) Pub. Date: Jul. 19, 2018

(54) TRANSPARENT GLASS HAVING PATTERN

(71) Applicant: DON CO., LTD., Gwangju-si, Gyeonggi-do (KR)

(72) Inventors: Do Hyun SHEEN, Seoul (KR); Hyun Deok JU, Icheon-si (KR)

(73) Assignee: DON CO., LTD., Gwangju-si, Gyeonggi-do (KR)

(21) Appl. No.: 15/741,494

(22) PCT Filed: Jul. 12, 2016
(86) PCT No.: PCT/KR2016/007543

§ 371 Date: Jan. 2, 2018

(30) Foreign Application Priority Data
Jul. 24, 2015 (KR) 10-2015-0104808
Feb. 29, 2016 (KR) 10-2016-0024308

(51) Int. Cl. C03C 15/00; C03C 17/245

(52) U.S. Cl. CPC C03C 15/00; C03C 17/245; C03C 2203/20; C03C 2218/34; C03C 2217/285; C03C 2217/77; C03C 2218/33; C03C 2217/21

(57) ABSTRACT

The present invention relates to transparent glass having a pattern and, more specifically, to transparent glass having a pattern, and having the purpose of allowing a dotted, linear or wave-shaped uneven surface to be formed on the surface of glass at low cost and improving fingerprint resistance, contamination resistance, water repellency and light transmittance by forming a fingerprint-resistant coating layer thereon, such that an uneven surface (100), which has a pattern groove (102) of any one of a plurality of dots, a plurality of linear forms, and a plurality of wave forms, is formed on the surface of a glass substrate by a deposition process or an etching process, a primer layer (40) and a fingerprint-resistant coating layer (50) are formed on the uneven layer, and the width or area of the pattern groove and the spacing distance between the pattern grooves are constant, thereby allowing the uneven surface to be systematically arranged.

### TECHNICAL FIELD

The present invention relates to transparent glass having a pattern, and more particularly, to transparent glass having a pattern which is manufactured by forming an uneven surface with a dotted, linear, or wavy pattern on a surface of display glass installed in a smartphone, a tablet PC, a netbook, a notebook, or the like or optical glass such as lenses of glasses and forming an anti-fingerprint coating layer thereon, and thus exhibits enhanced fingerprint resistance, enhanced anti-fouling effect, enhanced water repellency, and enhanced light transmittance.

### BACKGROUND ART

Recently, display glasses of smartphones, tablet PCs, netbooks, notebooks, and the like are made of tempered glass so as not to break easily, and techniques for imparting specific images, logos, characters, and the like to surfaces of these tempered glasses have been attempted.

As an example of related prior art, Korean Patent Application Registration No. 10-1295251 (Patent Document 1) discloses a method of performing image multi-deposition on a transparent display unit, including: (a) forming a coating layer on an upper or lower surface of a transparent display member to protect the surface thereof; (b) attaching a dry film photoresist (DFR) consisting of a variety of images including logos, characters, and letters to upper and lower portions of the coating layer; (c) performing a light exposure process by irradiating the DFR with ultraviolet light (UV) such that only a desired region is exposed to UV via a photomask; (d) performing a development process by removing the DFR positioned in the remaining region except for the UV-irradiated region of the transparent display member with the DFR attached thereto; (e) performing an etching process by removing the coating layer positioned in the remaining region except for the UV-irradiated region; and (f) performing a stripping process by removing the DFR attached to a variety of image regions when the etching process is completed.

However, when the method disclosed in Patent Document 1 is used, formation of a coating layer on a surface of tempered glass to protect the tempered glass needs to be followed by a DFR attachment process, a UV exposure process, a developing process, an etching process, a stripping process, and the like, and thus equipment or devices are needed to perform these processes, and it is time-consuming, thus being uneconomical.

In addition, instead of directly forming a pattern on a surface of tempered glass, a protective coating layer coated on the surface of the tempered glass forms a pattern, and thus, in a case in which touch of a finger frequently occurs as in a smartphone or a tablet PC, when in long-term use, the protective coating layer may be worn out or peeled off, resulting in poor durability of a pattern.

[Patent Document 1] Korean Patent Application Registration No. 10-1295251 (published on 9 Aug. 2013).

### DISCLOSURE

### Technical Problem

Therefore, the present invention has been made in view of the above problems, and it is one object of the present invention to provide transparent glass having a pattern which is manufactured by forming an uneven surface with a dotted, linear, or wavy pattern on a surface of glass and forming an anti-fingerprint coating layer thereon without using high technology and expensive equipment, using a simple process, and at low cost, and thus may exhibit enhanced fingerprint resistance, enhanced anti-fouling effect, enhanced water repellency, and enhanced light transmittance.

### Technical Solution

In accordance with one aspect of the present invention, provided is transparent glass having a pattern, including: an uneven surface having patterned grooves of any one of a plurality of dots, a plurality of linear forms, and a plurality of waveforms, the uneven surface being formed by performing a deposition process or an etching process on a surface of a glass substrate; and an anti-fingerprint coating layer formed on the uneven surface and having a thickness of 10 nm to 50 nm, wherein the patterned grooves have a width or area of 0.3 μm to 5 μm and a depth or height of 0.2 μm to 2 μm, and a distance between the patterned grooves ranges from 0.5 μm to 5 μm, wherein the width or area of each patterned groove and the separation distance between the patterned grooves are kept constant so that the uneven surface is regularly arranged.

In this regard, to enhance durability of the anti-fingerprint coating layer, a primer layer having a thickness of 10 nm to 30 nm may be disposed between the uneven surface and the anti-fingerprint coating layer.

### Advantageous Effects

According to the present invention, grooves of an uneven surface formed in an embossed or engraved shape on a surface of glass have a diameter or width of 0.3 μm to 5 μm, and can be easily fabricated and commercially viable without using high technology and expensive equipment, and manufacturing costs are not high, resulting in high price competitiveness, and a pattern can be arbitrarily and freely designed using a mask according to applications such as square or circular dots, linear forms, waveforms, and the like.

In addition, a contact angle of the surface of glass is maintained at 140° or more, and thus excellent anti-fouling effect and water repellency can be obtained and light transmittance can be enhanced.

Furthermore, an anti-fingerprint coating layer is formed on the uneven surface, and thus fingerprint resistance can be enhanced, and the anti-fingerprint coating layer is formed through a primer layer, and thus can have enhanced durability.

### DESCRIPTION OF DRAWINGS

FIG. 1 illustrates partial enlarged views of a surface of transparent glass having a pattern according to the present invention.

FIG. 2 illustrates partial enlarged views of a cross-section of the transparent glass having a pattern according to the present invention.

FIG. 3 illustrates partial enlarged views of a cross-section of glass to show a process of depositing the transparent glass having a pattern according to the present invention.

FIG. 4 illustrates partial enlarged views of a cross-section of glass to show a process of dry-etching the transparent glass having a pattern according to the present invention.

FIG. 5 illustrates partial enlarged views of a cross-section of glass to show a process of wet-etching the transparent glass having a pattern according to the present invention.

### DESCRIPTION OF REFERENCE NUMERALS

10 . . . glass substrate
20 . . . mask
21 . . . hole
30 . . . etching resist
40 . . . primer layer
50 . . . anti-fingerprint coating layer
100 . . . uneven surface
101 . . . deposition layer
102 . . . patterned groove

### BEST MODE

The present invention may have various modifications and various embodiments, and thus an embodiment of the present invention is characterized in that an uneven surface having patterned grooves of any one of a plurality of dots, a plurality of linear forms, and a plurality of waveforms is formed by performing a deposition process or an etching process on a surface of a glass substrate, and an anti-fingerprint coating layer having a thickness of 10 nm to 50 nm is formed on a surface of the uneven surface, wherein the patterned grooves have a width or area of 0.3 μm to 5 μm and a depth or height of 0.2 μm to 2 μm, and a distance between the patterned grooves ranges from 0.5 μm to 5 μm, wherein the width or area of each patterned groove and the distance between the patterned grooves are kept constant, and thus the uneven surface may be regularly arranged.

In this regard, to enhance durability of the anti-fingerprint coating layer, a primer layer having a thickness of 10 nm to 30 nm may be disposed between the uneven surface and the anti-fingerprint coating layer.

### [Mode]

Hereinafter, the present invention will be described in detail with reference to exemplary embodiments thereof. However, the embodiments set forth herein should not be construed as limiting the present invention, and illustrated general modifications, equivalents, or substitutions should be construed as being within the spirit and scope of the present invention.

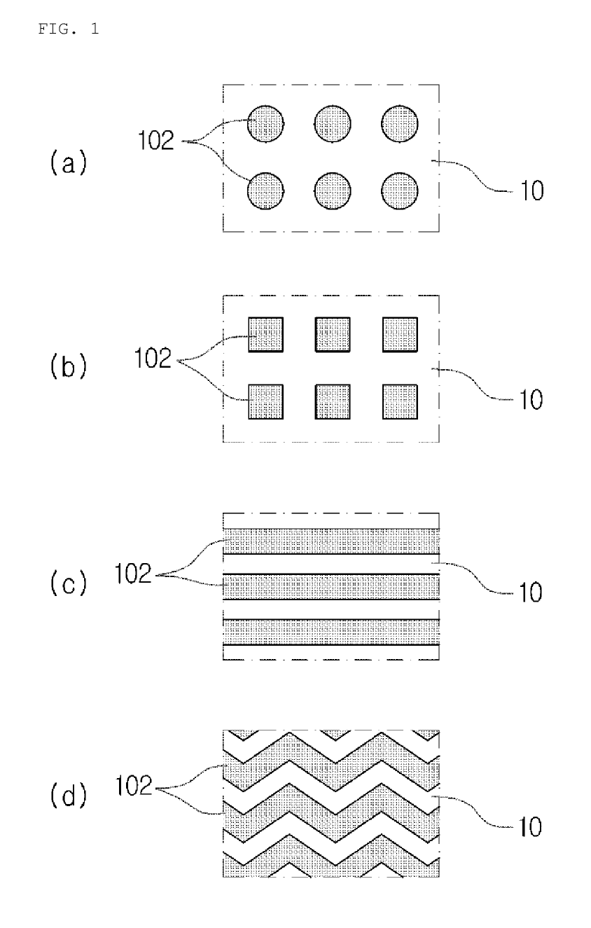

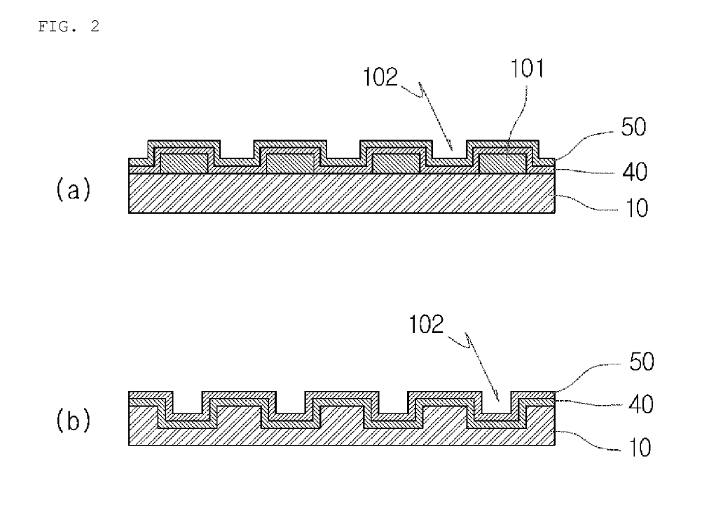

FIG. 1 illustrates partially enlarged views of a surface of transparent glass having patterns according to the present invention. FIG. 2 illustrates partially enlarged views of a cross-section of the transparent glass having patterns according to the present invention.

Referring to FIGS. 1 and 2, the transparent glass having patterns of the present invention has, on a surface of a glass substrate 10, an uneven surface 100 having patterned grooves 102 of any one of a plurality of circular dots (see FIG. 1(a)), a plurality of square dots (see FIG. 1(b)), a plurality of linear forms (see FIG. 1(c)), and a plurality of waveforms (see FIG. 1(d)).

The patterned grooves 102 may be formed by a deposition process as illustrated in FIG. 2(a), or may be formed by an etching process as illustrated in FIG. 2(b).

As illustrated in FIG. 2(a), when a deposition layer 101 is formed on the surface of the glass substrate 10 in a region except for the patterned grooves 102 through the deposition process, the patterned grooves 102 are formed in a region in which the deposition layer 101 is not formed. Unlike this, as illustrated in FIG. 2(b), the patterned grooves 102 may be formed on the surface of the glass substrate 10 by etching regions corresponding to the patterned grooves 102.

The patterned grooves 102 may have a width or area (diameter) of 0.3 μm to 5 μm, and a distance between the patterned grooves 102 may be arbitrarily adjusted within a range of 0.5 μm to 5 μm.

When the width or area (diameter) of the patterned grooves 102 is less than 0.3 μm, and the distance between the patterned grooves 102 is less than 0.5 μm, precise and expansive equipment and complicated processes are required, and thus manufacturing costs increase, thus reducing price competitiveness, resulting in difficulty in commercialization, and it is difficult to uniformly form the width or area of each patterned groove 102, and thus it is difficult to regularly form the uneven surface. On the other hand, when the width or area of the patterned grooves 102 and the distance between the patterned grooves 102 are greater than 5 μm, patterns on a surface of glass are distinguishable with the naked eye, and thus marketability thereof deteriorates, and it is difficult to achieve improvement in fingerprint resistance, an anti-fouling effect, water repellency, and light transmittance that are to be achieved by the present invention.

The height of the patterned grooves 102, i.e., the height of the deposition layer 101 formed by the above-described deposition process, and the depth of the patterned grooves 102 etched by an etching process may be adjusted within a range of 0.2 μm to 2 μm.

When the height or depth of the patterned grooves 102 is less than 0.2 μm, a level difference of the uneven surface is small, and thus it is difficult to achieve improvement in fingerprint resistance, an anti-fouling effect, water repellency, and light transmittance that are exhibited by the uneven surface on the surface of the glass substrate 10. On the other hand, when the height or depth of the patterned grooves 102 is greater than 2 μm, the deposition process or the etching process is time-consuming, resulting in poor mass productivity, and the height or depth of each patterned groove 102 is not uniform, and thus it is difficult to achieve an uneven surface with a uniform pattern over the entire surface of the glass substrate 10.

Meanwhile, a primer layer 40 and an anti-fingerprint coating layer 50 may be sequentially stacked on the uneven surface 100 formed by the patterned grooves 102 on the surface of the glass substrate 10, or the anti-fingerprint coating layer 50 may be directly formed on the uneven surface 100 without the primer layer 40.

The primer layer 40 may be formed using a binder resin that enhances adhesion thereof to the anti-fingerprint coating layer 50 to minimize separation or peeling of the anti-fingerprint coating layer 50, and the binder resin may include, for example, an acrylic polymer resin and a water-dispersed polyester copolymer resin.

A maximum thickness of the primer layer 40 and the anti-fingerprint coating layer 50 or the anti-fingerprint coating layer 50 may be smaller than a lower limit of the width or area range of the patterned grooves 102, and, for example, the primer layer 40 may have a thickness of 10 nm to 30 nm and the anti-fingerprint coating layer 50 may have a thickness of 10 nm to 50 nm.

When the thickness of each of the primer layer 40 and the anti-fingerprint coating layer 50 is less than 10 nm, it is difficult to maintain a uniform thickness thereof over the entire surface of the glass substrate 10, and precise and expensive equipment is required for formation of the uniform thickness over the entire surface, resulting in low price competitiveness. On the other hand, when the thicknesses of the primer layer 40 and the anti-fingerprint coating layer 50 are greater than 30 nm and 50 nm, respectively, boundaries between regions in which the patterned grooves 102 are formed and a region in which the patterned grooves 102 are not formed are largely lost, and thus the uneven surface 100 is not distinct, and, accordingly, it is difficult to achieve improvement in fingerprint resistance, an anti-fouling effect, water repellency, and light transmittance that are to be achieved by the present invention.

Hereinafter, deposition and etching processes for forming the patterned grooves 102 on the surface of the glass substrate 10 will be described, and the present invention will become more apparent from the following description.

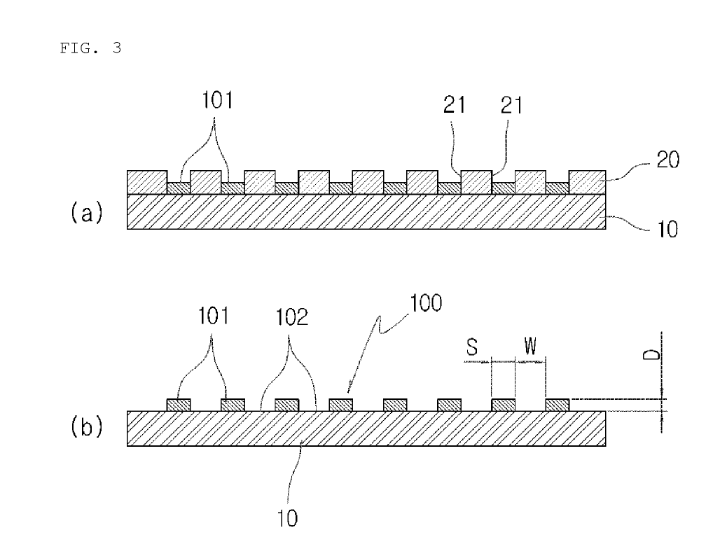

FIG. 3 illustrates partially enlarged views of a cross-section of glass to show a process of depositing the transparent glass having patterns according to the present invention.

Referring to FIG. 3(b), in the transparent glass having patterns according to an embodiment of the present invention, a transparent deposition layer 101 having a height D of 0.2 μm to 2 μm and formed of an oxide or a fluoride is formed on a surface of the glass substrate 10, and the uneven surface 100 with predetermined patterns is formed in an embossed shape by the transparent deposition layer 101.

The deposition process for forming the transparent deposition layer 101 includes, as illustrated in FIG. 3(a), washing and drying the glass substrate 10 and then attaching a mask 20 thereto, depositing an oxide or a fluoride on holes 21 of the mask 20 to a height of 0.2 μm to 2 μm in a vacuum environment, and removing the mask 20.

In this regard, the mask 20 has closed patterned regions corresponding to the patterned grooves 102 and the holes 210 through which the remaining region is exposed. Accordingly, as illustrated in FIG. 3(b), deposition is not performed on the closed regions of the mask 20, and an oxide or a fluoride may be deposited on the surface of the glass substrate 10 through the holes 21, thereby forming the uneven surface 100 having the patterned grooves 102 of any one of dots, linear forms, and waveforms.

Deposition of the oxide or the fluoride may be performed in a pressure-reduced vacuum environment, and may be performed using known vacuum deposition equipment.

Examples of the oxide for forming the transparent deposition layer 101 include SiO₂ and MgF₂, and the fluoride may be a structure in which a fluorine organic material and silane are linked to each other. However, materials for forming the transparent deposition layer 101 are not limited to the above-listed materials, and any other known materials capable of forming the transparent deposition layer 101 may be used.

The primer layer 40 and/or the anti-fingerprint coating layer 50 are formed on the surface of the glass substrate 10 having the uneven surface 100 after performing the above-described process of removing the mask 20.

The anti-fingerprint coating layer 50 may be, for example, a mixture of a fluorine coating agent and a volatile solvent, prepared using a process generally performed in other fields such as optical glasses as well as display glasses of electronic devices, and may also be formed using a material known as an anti-fingerprint coating agent, and thus the material thereof is not particularly limited.

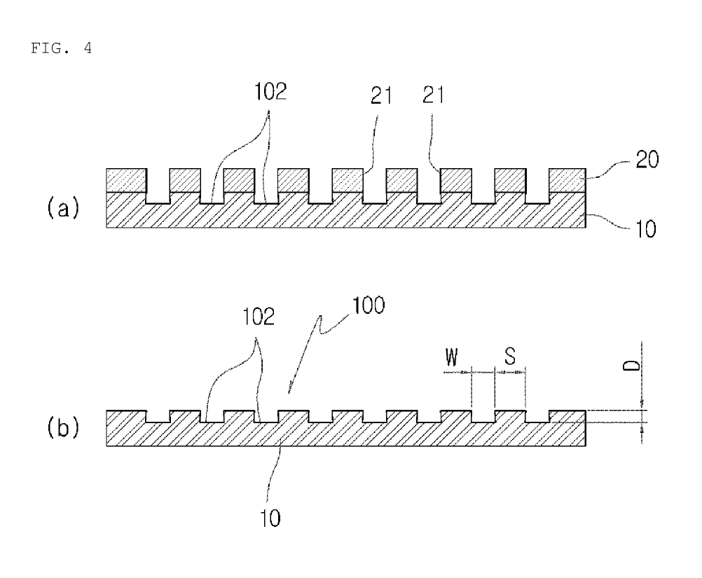

FIG. 4 illustrates partially enlarged views of a cross-section of glass to show a process of dry-etching the transparent glass having patterns according to the present invention.

Referring to FIG. 4(b), in the transparent glass having patterns according to an embodiment of the present invention, the patterned grooves 102 are formed at a surface of the glass substrate 10 to a depth D of 0.2 μm to 2 μm so that the uneven surface 100 is formed in an engraved shape by the patterned grooves 102 formed at the surface of the glass substrate 10.

The process of forming the uneven surface 100 includes, as illustrated in FIG. 4(a), washing and drying the glass substrate 10 and attaching the mask 20 thereto, forming the patterned grooves 102 by dry-etching the surface of the glass substrate 10 exposed via the holes 21 of the mask 20 to a depth of 0.2 μm to 2 μm, and removing the mask 20.

The mask 20 has the holes 20 through which regions corresponding to the patterned grooves 102 are exposed and a closed remaining region, i.e., a region that does not correspond to the patterned grooves 102.

Thus, the closed region of the mask 20 is not etched, and only the regions in which the holes 21 are positioned are etched, thereby, as illustrated in FIG. 4(b), completing fabrication of the glass substrate 10 having the uneven surface 100 formed by the patterned grooves 102.

Dry etching may be performed by ionizing an inert argon gas by high frequency discharge or using plasma of a gas containing a halogen element, and such a dry etching method may be selected from among generally commercially available known methods.

When the patterned grooves 102 are formed through dry etching, etching may be performed such that the patterned grooves 102 can have an isosceles trapezoidal lateral cross-sectional shape to reduce light reflectance.

The primer layer 40 and/or the anti-fingerprint coating layer 50 are formed on the surface of the glass substrate 10 having the uneven surface 100 formed after performing the above-described process of removing the mask 20.

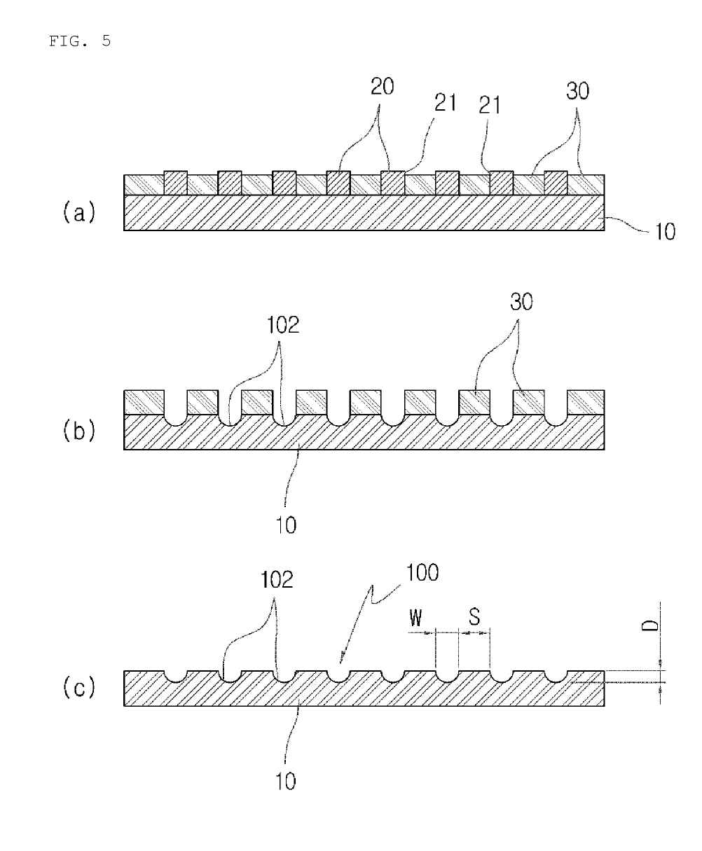

FIG. 5 illustrates partially enlarged views of a cross-section of glass to show a process of wet-etching the transparent glass having patterns according to the present invention.

Referring to FIG. 5(c), in the transparent glass having patterns according to an embodiment of the present invention, the patterned grooves 102 are formed on a surface of the glass substrate 10 to a depth D of 0.2 μm to 2 μm so that the uneven surface 100 with predetermined patterns is formed in an engraved shape by the patterned grooves 102 formed on the surface of the glass substrate 10.

The process of forming the uneven surface 100 includes, as illustrated in FIG. 5(a), washing and drying the glass substrate 10 and attaching the mask 20 thereto, forming an etching resist layer 30 on the surface of the glass substrate 10 by applying an etching resist to the holes 21 of the mask 20, removing the mask 20, forming the patterned grooves 102 by wet-etching a region of the surface of the glass substrate 10 in which the etching resist layer 30 is not formed, to a depth of 0.2 μm to 2 μm, and removing the etching resist layer 30 using a remover.

The mask 20 has closed patterned regions corresponding to the patterned grooves 102 and the holes 21 through which the remaining region is exposed.

Thus, the mask 20 having the holes 21 passing therethrough is attached to the surface of the glass substrate 10, and then an etching resist ink is printed thereon and passes through the holes 21, thereby forming an etching resist layer 30, and the etching resist layer 30 is dried.

Subsequently, as illustrated in FIG. 5(b), when the mask 20 is removed from the surface of the glass substrate 10, the etching resist layer 30 is formed on the surface of the glass substrate 10 in predetermined patterns, i.e., patterns corresponding to the holes 21. In this state, when a wet etching process is performed by being dipped in or spraying an acidic etchant such as hydrofluoric acid or the like, a portion of the surface of the glass substrate 10, in which the etching resist layer 30 is not formed, is etched, thereby forming the patterned grooves 102.

Next, after the patterned grooves 102 are formed, the glass substrate 10 is washed using a remover such as acetone or the like to remove the etching resist layer 30, thereby, as illustrated in FIG. 5(c), completing the fabrication of the glass substrate 10 having the uneven surface 100 formed by the patterned grooves 102, and the patterned grooves 102 may have any one of a dotted shape, a linear shape, and a wavy shape.

In a case in which the patterned grooves 102 are formed through such wet etching, the patterned grooves 102 may have a semicircular lateral cross-sectional shape to reduce light reflectance.

The primer layer 40 and/or the anti-fingerprint coating layer 50 are formed on the surface of the glass substrate 10 having the uneven surface 100 in a state in which the etching resist layer 30 is removed.

In FIGS. 3 to 5, as described above, a width or area W of the patterned grooves 102 ranges from 0.3 μm to 5 μm, a separation distance S between the patterned grooves 102 ranges from 0.5 μm to 5 μm, and a depth or height of the patterned grooves 102 ranges from 0.2 μm to 2 μm. These numerical ranges do not require high precision, and thus expensive deposition or etching equipment is not required, and formation thereof is easy, and thus the uneven surface 100 may be formed at minimum cost and the width or area W of each patterned groove 102 and the separation distance S between the patterned grooves 102 may be constantly and uniformly processed over the entire surface of the glass substrate 10, and, accordingly, the uneven surface 100 formed on the surface of the glass substrate 10 may be regularly arranged.

### Experimental Example 1

Light Transmittance Test

To investigate light transmittance of glass having patterns of the present invention, patterned grooves having a depth of 2 μm were formed on a surface of tempered glass having a thickness of 0.8 mm through the above-described dry etching process. At this time, the patterned grooves had a circular dotted shape, each patterned groove had an area (diameter) of 3 μm, and a distance between the patterned grooves was 3 μm in front, rear, left and right directions. For reliability of experimental data, three samples AG1 to AG3 were prepared.

In addition, tempered glass (bare) having a flat plate shape and a thickness of 0.8 mm on which patterned grooves were not formed was prepared as a comparative material.

Light transmittances of the samples AG1 to AG3 according to one embodiment of the present invention and the comparative sample (bare) with no patterns were measured at a visible light wavelength ranging from 400 nm to 700 nm using a spectrophotometer (Model Name: U-4100), and results thereof are shown in Table 1 below.

TABLE 1

| Wavelength | | | | |
|---|---|---|---|---|
| (visible light) | AG1 | AG2 | AG3 | Bare |
| 400 nm | 92.8 | 92.5 | 92.7 | 92.2 |
| 450 nm | 93.0 | 92.9 | 92.9 | 92.3 |
| 500 nm | 93.0 | 93.0 | 93.0 | 92.4 |
| 550 nm | 93.1 | 92.9 | 93.0 | 92.5 |
| 600 nm | 93.0 | 92.8 | 92.9 | 92.4 |
| 650 nm | 92.9 | 92.7 | 92.7 | 92.3 |
| 700 nm | 93.0 | 92.7 | 92.7 | 92.4 |

As seen in Table 1, it was confirmed that the pattern samples AG1, AG2, and AG3 of the present invention had average light transmittances of 92.96 nm, 92.79 nm, and 92.84 nm, respectively, at a wavelength of 400 nm to 700 nm, which were higher than that of the comparative material having an average light transmittance of 92.45 nm.

### Experimental Example 2

Contact Angle Test

The same samples and comparative material as those of Experimental Example 1 were fabricated, and, as a result of measuring a surface contact angle of a 3 μm water drop, the samples with patterned grooves of the present invention had an average contact angle of 140±1°, while the comparative material had an average contact angle of 101±0.8°, from which it was confirmed that a glass substrate with patterned grooves formed according to the present invention exhibits excellent water repellency.

While the present invention has been particularly described with reference to exemplary embodiments thereof, the present invention should not be construed as being limited to particular embodiments or numerical ranges, various modifications may be made by those of ordinary skill in the art to which the present invention pertains by changing and combining some elements of embodiments without departing from the essence of the present invention claimed by the following claims, and such modified embodiments should not be individually understood from the spirit or scope of the present invention.

1. Transparent glass having patterns, comprising
an uneven surface having patterned grooves of any one of a plurality of dots, a plurality of linear forms, and a plurality of waveforms, the uneven surface being formed by performing a deposition process or an etching process on a surface of a glass substrate; and
an anti-fingerprint coating layer formed on the uneven surface and having a thickness of 10 nm to 50 nm,
wherein the patterned grooves have a width or area of 0.3 μm to 5 μm, and a distance between the patterned grooves ranges from 0.5 μm to 5 μm,
wherein the width or area of each patterned groove and the separation distance between the patterned grooves are kept constant so that the uneven surface is regularly arranged.

2. The transparent glass according to claim 1, wherein a primer layer having a thickness of 10 nm to 30 nm is disposed between the uneven surface and the anti-fingerprint coating layer.

3. The transparent glass according to claim 1 or 2, wherein the deposition process comprises attaching a mask having closed pattern regions corresponding to the patterned grooves and an opened region through which the remaining region is exposed, depositing an oxide or a fluoride on the opened region of the mask to a height of 0.2 μm to 2 μm in a vacuum environment, and removing the mask.

4. The transparent glass according to claim 1 or 2, wherein the etching process comprises attaching a mask having opened pattern regions corresponding to the patterned grooves and a closed remaining region, forming the patterned grooves by dry-etching the surface of the transparent glass, corresponding to the opened regions of the mask to a depth of 0.2 μm to 2 μm, and removing the mask.

5. The transparent glass according to claim 1 or 2, wherein the etching process comprises attaching a mask having closed pattern regions corresponding to the patterned grooves and an opened region through which the remaining region is exposed, forming an etching resist layer on the surface of the glass substrate by applying an etching resist to the opened region of the mask, removing the mask, forming the patterned grooves by wet-etching the surface of the glass substrate, corresponding to a region in which the etching resist layer is not formed, to a depth of 0.2 μm to 2 μm, and removing the etching resist layer using a remover.
